(19) United States
(12) Patent Application Publication
(10) Pub. No.: US 2012/0140215 A1
(43) Pub. Date: Jun. 7, 2012

(54) RETRO-REFLECTOR MICROARRAY AND APPLICATION THEREOF

(76) Inventors: Fu-Jen KAO, Taipei City (TW); Shih-Hao Lin, Taipei City (TW); Po-Yen Lin, Taipei City (TW); Yung-En Kuo, Taipei City (TW)

(21) Appl. No.: 13/217,968

(22) Filed: Aug. 25, 2011

(30) Foreign Application Priority Data
Dec. 7, 2010 (TW) 099142559

(51) Int. Cl. G01J 3/44; G02B 5/124

(52) U.S. Cl. 356/301; 359/530

(57) ABSTRACT

The present invention relates to a retro-reflector microarray including a plurality of micro retro-reflectors arranged on a common plane. Each of the retro-reflectors is a concave corner cube consisting of three mutually orthogonal reflective surfaces. The concave corner cubes are the main reflecting elements of the microarray and make the reflected light anti-parallel to the incident light. The retro-reflector microarray can be used in optical detection instrument as an auxiliary element for remotely scanning fluorescence and Raman signals.

### BACKGROUND OF THE INVENTION

1. Field of the Invention

The present invention relates to a retro-reflector microarray particularly suitable for biomedical optics and photonic detection. The retro-reflector microarray can reflect stimulated emission (fluorescence and Raman) whereby fluorescence and Raman signals of samples can be distantly scanned.

2. Description of the Related Art

In the field of biomedicine sensing, nucleic acid amplification is often used to duplicate and amplify a small amount of a nucleic acid sample to a detectable amount. The amplified nucleic acid product is further treated with probe hybridization so that nucleic acid probes with fluorescent dye can be linked to the target nucleic acid fragments. By being irradiated with the excitation light source having wavelengths matching to the fluorescence (and Raman signal), the target nucleic acid will emit specific optical signals (fluorescence and Raman signals). The signals are then detected and analyzed by the imaging and spectroscopy analyzer.

For the specific fluorescent dyes, the excitation light source with a specific range of wavelengths is required. When irradiated by light beams of proper wavelengths (e.g. ultraviolet), the fluorescence molecules will absorb the energy of the light and transit to a higher energy level. Then within a very short period of time (10⁻⁸-10⁻⁴ second), the electrons will return to the lower energy level and release energy in the form of fluorescence. If the transition to the higher states is virtual, the emitted signal is then a Raman one. The spontaneous fluorescence and Raman scattering are spatially isotropic (i.e., emitting in a solid angle of 4π) or non-coherent. In order to collect more non-coherent fluorescence and Raman signals, the optical elements (such as high numerical aperture optics) have to be positioned very close to the sample due to the small size of the lens. However, the numerical apertures of the optical elements may still be limited so that the strengths of the collected signals are insufficient and noises may be relatively high.

On the other hand, it is also known that excited fluorescence molecules can generate relatively coherent fluorescence signals through stimulated emission and the detection limit can reach 10⁻²¹ mol. The coherent fluorescent signals can then be distantly detected by optical elements with small numerical apertures. Effects of the corresponding optical components should then be improved.

### SUMMARY OF THE INVENTION

The object of the present invention is to provide a retro-reflector shaped microarray. The retro-reflector microarray includes a plurality of micro retro-reflectors arranged on a common plane to form a microarray structure. The retro-reflectors can be arranged continuously or discreetly, regularly or irregularly, and as duplicated patterns or else. The retro-reflector shaped (or patterned) microarray can reflect coherent stimulated fluorescence and Raman emission induced by laser so that samples can be distantly scanned and the fluorescence and Raman signals can achieve higher strengths and lower noise-to-signal ratios.

Each of the retro-reflectors is a concave corner cube consisting of three mutually orthogonal reflective surfaces along the X-, Y- and Z-axes. Within each retro-reflector, v-shaped grooves constituted by two adjacent reflective surfaces along the X-, Y- and Z-axes form a main reflecting component to make the reflected light parallel to the incident light. The retro-reflector microarray can be an auxiliary element used in biomedical optical detection for distant scanning of fluorescence and Raman signals.

### DETAILED DESCRIPTION OF THE PREFERRED EMBODIMENTS

To further describe the present invention, the preferred embodiment is illustrated. It is necessary to note that elements are drawn for explaining the ratio, size, deformation or displacement but not proportional to the real elements. Furthermore, similar elements are designated identical numbers in the drawings.

FIG. 1 shows two adjacent retro-reflectors (10) of this invention. Each retro-reflector (10) is a concave corner cube including three mutually orthogonal reflective surfaces (11, 12, 13) along the X-, Y- and Z-axes. The reflective surfaces (11, 12, 13) are all right triangles and bases (a, b, c) thereof are the same in length.

FIG. 2 is the cross-sectional view of the retro-reflectors (10). Within the retro-reflector (10), v-shaped grooves constituted by two adjacent reflective surfaces along the X-, Y-and Z-axes form a main reflecting component to make the reflected light parallel to the incident light. In another embodiment, the reflective surfaces of the retro-reflector (10) can be different shapes and geometric except triangle.

FIG. 3 is the plane view of a retro-reflector microarray (15) including more retro-reflectors as shown in FIG. 1. The retro-reflectors are closely arranged on a common plane so that the adjacent retro-reflectors share the same base. This embodiment illustrates one of arrangements of the retro-reflectors but not limit the present invention. The retro-reflectors also can be arranged continuously or discretely, regularly or irregularly, as duplicated patterns or not.

FIG. 4 shows the retro-reflector microarray (15) capable of reflecting incoming light of different angles of incidence in parallel and opposite directions.

The retro-reflector microarray of the present invention can be used to distantly scan samples and collect fluorescence and Raman signals generated by stimulated emission. The invention is further exemplified by detecting a nucleic acid sample coupled with fluorescent dye. Laser is provided as an excitation source and a stimulating source of fluorescence and Raman. When the sample is irradiated with excitation beams and stimulating beams, electrons thereof transit to a higher energy (virtual) level and then return with fluorescence (and Raman) emission. The fluorescence and Raman emission is highly coherent.

FIG. 5 shows the application of the retro-reflector array to transmission detection. The excitation beams (30) and stimulating beams (31) irradiate the sample (50) through a scanner (40), for example, a galvo mirror. Along the direction of the incident laser ray, the retro-reflector microarray (15) of the present invention is disposed behind the sample (50). The sample (50) is scanned entirely and each incident laser ray through the respective point of the sample is guided to the retro-reflector microarray (15) and reflected to the scanner (40) in a parallel and opposite direction. The scanner (40) is connected to a detector (60) for detecting the fluorescence and Raman signals from the stimulated emission.

FIG. 6 further illustrates the transmission detection. The incident excitation beams (30) and the stimulating beams (31) are modulated to achieve the optimal efficiency. The beams pass through the scanner (40) such as galvo mirror and penetrate the sample (50) to reach the retro-reflector microarray (15). The stimulated fluorescence and Raman emission with high coherence also reaches the retro-reflector microarray (15). Then the beams are reflected to the scanner (40) from the retro-reflector microarray (15) in a parallel and opposite direction via the same point. That is, the reflected beams include the reflected laser beams and the reflected fluorescence and Raman beams. The detector (60) including a filter (61) is connected to the scanner (40) to filter out the laser beams. Then the fluorescence and Raman signals can be detected after being demodulated with a phase-locked amplifier (62).

In the present invention, the retro-reflectors are arranged in a microarray way on a common plane to receive the incident beam (stimulated beam or stimulated coherent fluorescence and Raman) from each scanning point of the sample (50). The coherent fluorescence and Raman beams from all scanning points will reach to the detector. The positions and the angles that the reflected beams return to the scanner (40) are predictable. The detector can thus receive all the reflected beams at a fixed position. The detector can also be installed distance from the sample to collect all the reflected beams from each scanning point. In addition, such a remote scanning can promote strengths of the signals, lower noise-to-signal ratio and increase accuracy in interpreting the fluorescence and Raman signals.

While this invention has been particularly illustrated with references to preferred embodiments thereof, it will be understood by those skilled in the art that various changes in form and details may be made therein without departing from the scope of the invention encompassed by the appended claims. Any modification or change not departing from the main idea of the present invention is within the scope of the patent claimed.

### BRIEF DESCRIPTION OF THE DRAWINGS

FIG. 1 shows the retro-reflectors of the present invention.

FIG. 2 is the cross-sectional view of the retro-reflector of the present invention.

FIG. 3 is the plan view of the retro-reflector microarray of the present invention.

FIG. 4 is the plan view showing the beams irradiating and reflected from the retro-reflector microarray of the present invention.

FIG. 5 shows the application of the retro-reflector array to transmission detection.

FIG. 6 further shows the application of the retro-reflector array to transmission detection.

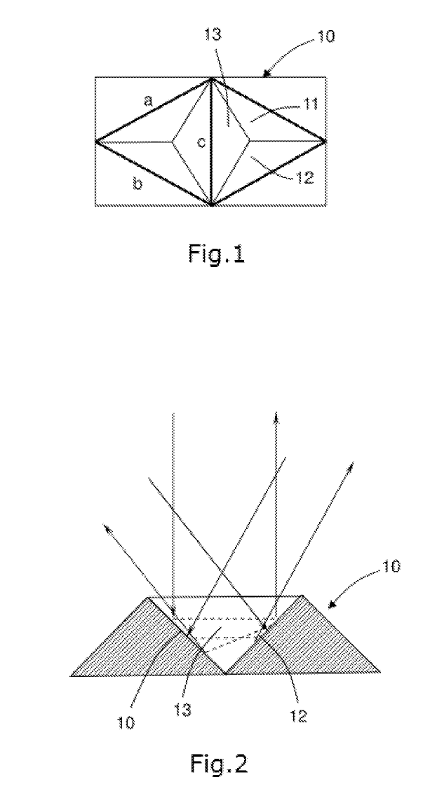

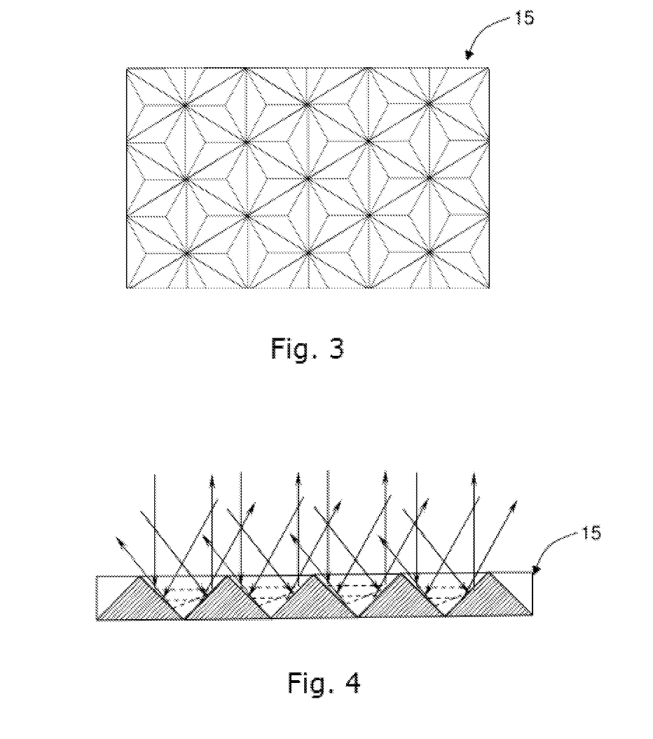

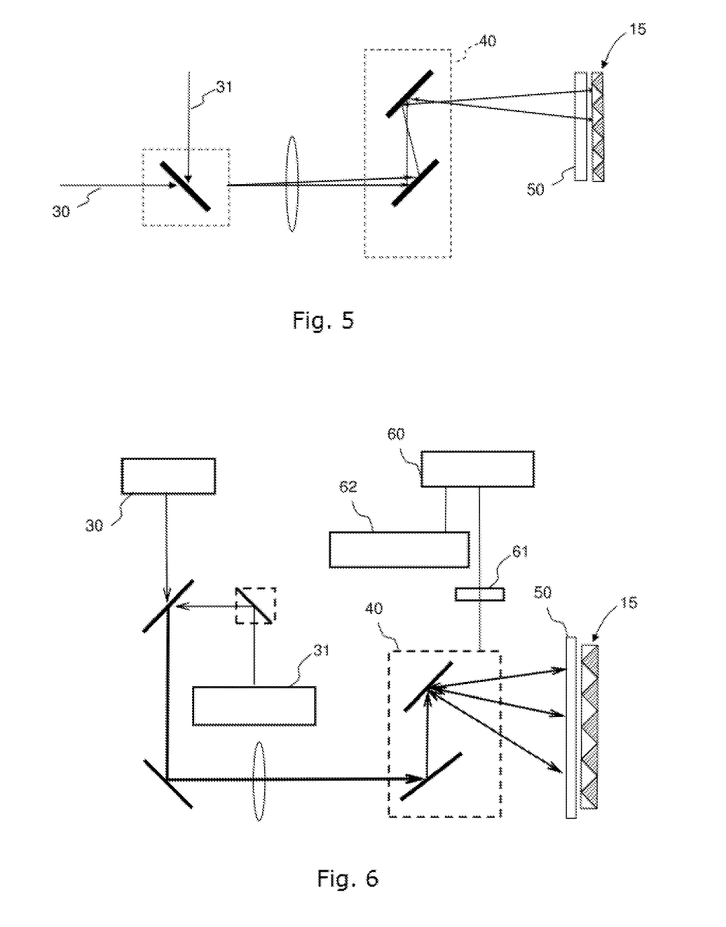

What is claimed is:

1. A retro-reflector microarray comprising:
a plurality of micro retro-reflectors arranged on a common plane to form a microarray;
wherein each of the retro-reflectors is a concave corner cube including three mutually orthogonal reflective surfaces along x-, y- and z-axes to make reflected beams parallel to incident beams.

2. The retro-reflector microarray of claim 1, wherein the reflective surface is a geometric plane.

3. The retro-reflector microarray of claim 1, wherein the retro-reflectors are arranged adjacently on the common plane.

4. The retro-reflector microarray of claim 1, wherein the retro-reflectors are arranged as duplicated patterns on the common plane.

5. The retro-reflector microarray of claim 1, wherein the retro-reflectors are continuously or discretely arranged on the common plane.

6. The retro-reflector microarray of claim 1, wherein the retro-reflectors are regularly or irregularly arranged on the common plane.

7. The retro-reflector microarray of claim 1, wherein the incident beams are coherent light generated by stimulated emission.

8. The retro-reflector microarray of claim 7, wherein the incident beams are highly coherent light generated from fluorescent molecules which are stimulated by laser and transit to a higher energy level.

9. An application of the retro-reflector microarray of claim 1, which is used in optical detection instrument as an auxiliary element for remotely scanning fluorescent signals.

10. A transmission detection unit comprising:
a laser source providing laser beams;
a scanner connected to the laser source so that a sample coupled with fluorescent dye is irradiated by the laser beams through the scanner and generate coherent stimulated fluorescence and Raman;
a retro-reflector microarray of claim 1 disposed behind the sample relative to the scanner so that the stimulated fluorescence and Raman is reflected to the scanner; and
a detector connected to the scanner so that the reflected stimulated fluorescence and Raman is detected.

11. The transmission detection unit of claim 10, wherein the laser source provides incident excitation beams and stimulating emission beams.

12. The transmission detection unit of claim 10, wherein the detector comprises a filter connected to the scanner to filter out reflected laser beams.
